(19) United States
(12) Patent Application Publication
(10) Pub. No.: US 2026/0368749 A1
(43) Pub. Date: Nov. 19, 2026

(54) PERIPHERAL DEVICES FOR REAL-TIME REQUESTS

(71) Applicant: QUALCOMM Incorporated, San Diego, CA (US)

(72) Inventors: Xiaoting XU, Shanghai (CN); Weimeng HUANG, Shanghai (CN); Weidong YANG, Shanghai (CN); Nicolas GRAUBE, Cambridge (GB)

(21) Appl. No.: 19/146,884

(22) PCT Filed: Feb. 23, 2023
(86) PCT No.: PCT/CN2023/077771

§ 371 Date: Jul. 9, 2025

(51) Int. Cl. G06Q 30/015; H04W 4/33; H04W 4/35; H04W 88/08

(52) U.S. Cl. CPC G06Q 30/015; H04W 4/33; H04W 4/35; H04W 88/08

(57) ABSTRACT

Disclosed are systems, apparatuses, processes, and computer-readable media for wireless communications. In one illustrative example, a network device can receive, from a first wireless communication device, user support information for a user. The user support information can include an identification of a shelving unit and/or an identification of an assistant. The network device can transmit, to a second wireless communication device, a user support request including the identification of the shelving unit and/or the identification of the assistant.

### FIELD OF THE DISCLOSURE

The present disclosure generally relates to wireless communications. For example, aspects of the present disclosure relate to using wireless communication devices, such as peripheral devices (e.g., electronic shelf labels (ESLs)), for managing real-time requests.

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one illustrative example, a method of wireless communication performed at a network device is provided. The method includes: receiving, by the network device from a first wireless communication device, user support information for a user, wherein the user support information comprises at least one of an identification of a shelving unit or an identification of an assistant; and transmitting, by the network device to a second wireless communication device, a user support request comprising at least one of the identification of the shelving unit or the identification of the assistant.

In another example, a network device for wireless communication is provided. The network device includes at least one memory and at least one processor coupled to the at least one memory. The at least one processor is configured to: receive, from a first wireless communication device, user support information for a user, wherein the user support information comprises at least one of an identification of a shelving unit or an identification of an assistant; and output, for transmission to a second wireless communication device, a user support request comprising at least one of the identification of the shelving unit or the identification of the assistant.

In another example, a non-transitory computer-readable medium is provided that has stored thereon instructions that, when executed by one or more processors, cause the one or more processors to: receive, from a first wireless communication device, user support information for a user, wherein the user support information comprises at least one of an identification of a shelving unit or an identification of an assistant; and output, for transmission to a second wireless communication device, a user support request comprising at least one of the identification of the shelving unit or the identification of the assistant.

In another example, an apparatus for wireless communication is provided. The apparatus includes: means for receiving, from a first wireless communication device, user support information for a user, wherein the user support information comprises at least one of an identification of a shelving unit or an identification of an assistant; and means for transmitting, to a second wireless communication device, a user support request comprising at least one of the identification of the shelving unit or the identification of the assistant.

In another example, a method of wireless communication performed at a wireless communication device is provided. The method includes: receiving, by the wireless communication device from a network device, a user support request comprising an identification of a shelving unit; and outputting, by the wireless communication device, a prompt upon receipt of the user support request, wherein the prompt comprises the identification of the shelving unit.

In another example, a wireless communication device for wireless communication is provided. The wireless communication device includes at least one memory and at least one processor coupled to the at least one memory. The at least one processor is configured to: receive, from a network device, a user support request comprising an identification of a shelving unit; and output a prompt upon receipt of the user support request, wherein the prompt comprises the identification of the shelving unit.

In another example, a non-transitory computer-readable medium is provided that has stored thereon instructions that, when executed by one or more processors, cause the one or more processors to: receive, from a network device, a user support request comprising an identification of a shelving unit; and output a prompt upon receipt of the user support request, wherein the prompt comprises the identification of the shelving unit.

In another example, an apparatus for wireless communication is provided. The apparatus includes: means for receiving, from a network device, a user support request comprising an identification of a shelving unit; and means for outputting a prompt upon receipt of the user support request, wherein the prompt comprises the identification of the shelving unit.

In another example, a method of wireless communication performed at a first wireless communication device is provided. The method includes: scanning, by the first wireless communication device, a code displayed on a second wireless communication device associated with a shelving unit; determining, by the first wireless communication device, user support information based on the code, wherein the user support information comprises at least one of an identification of the shelving unit or an identification of an assistant associated with the shelving unit; and transmitting, by the first wireless communication device to a network device, the user support information.

In another example, a first wireless communication device for wireless communication is provided. The wireless communication device includes at least one memory and at least one processor coupled to the at least one memory. The at least one processor is configured to: scan a code displayed on a second wireless communication device associated with a shelving unit; determine user support information based on the code, wherein the user support information comprises at least one of an identification of the shelving unit or an identification of an assistant associated with the shelving unit; and output, for transmission to a network device, the user support information.

In another example, a non-transitory computer-readable medium is provided that has stored thereon instructions that, when executed by one or more processors, cause the one or more processors to: scan a code displayed on a second wireless communication device associated with a shelving unit; determine user support information based on the code, wherein the user support information comprises at least one of an identification of the shelving unit or an identification of an assistant associated with the shelving unit; and output, for transmission to a network device, the user support information.

In another example, an apparatus for wireless communication is provided. The apparatus includes: means for scanning a code displayed on a wireless communication device associated with a shelving unit; means for determining user support information based on the code, wherein the user support information comprises at least one of an identification of the shelving unit or an identification of an assistant associated with the shelving unit; and means for transmitting, to a network device, the user support information.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a diagram illustrating an example of a system for using wireless communication devices, such as ESLs, for managing customers' real-time requests, in accordance with some aspects of the present disclosure.

FIG. 5 is a signaling diagram illustrating an example of communication transmissions for between a network device and wireless communication devices, in accordance with some aspects of the present disclosure.

FIG. 6 includes tables showing examples of different device types for wireless communication devices and their associated values, in accordance with some aspects of the present disclosure.

FIG. 7 includes tables showing examples of different advertising types for customer real-time support (CRTP) and access commands for CRTP requests, in accordance with some aspects of the present disclosure.

FIG. 8 is a flow chart illustrating an example of a process for wireless communications at a network device, in accordance with some aspects of the present disclosure.

FIG. 9 is a flow chart illustrating an example of a process for wireless communications at a wireless communication device, in accordance with some aspects of the present disclosure.

FIG. 10 is a block diagram illustrating an example of a computing system, which may be employed by the disclosed systems and techniques for using wireless communication devices, such as ESLs, for managing customers' real-time requests, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. For example, an electronic shelf label (ESL) system may include one or more wireless communication devices (e.g., ESLs) that are controlled by a network entity, such as a management entity (ME), via at least one network device, such as an access point (AP). In one or more examples, to facilitate control by the management entity, each ESL may have a wireless connection (e.g., a BLUETOOTH® Low Energy (BLE) connection or other connection) to an access point (AP) that is communicatively connected to the management entity (e.g., via the Internet, such as wirelessly, via an Ethernet connection, etc.). In some cases, commands from the management entity may be wirelessly transmitted to the ESLs by the access point. Responses or information from the ESLs may also be received by the access point and provided by the access point to the management entity. While examples are described herein using ESLs as illustrative examples of wireless communication devices, a management entity as an example of a network entity, and access points as examples of network devices, the systems and techniques described herein are applicable to any type of system or network.

In ESL systems, periodic advertisements (PAs) are often utilized to provide regular and predictable payload transmissions from a network device, such as an access point, to one or more wireless communication devices, such as ESLs. For example, PAs can be used to issue information from a network device to multiple wireless communication devices, which may be within one or more groups of wireless communication devices. PAs are generally unidirectional (e.g., unidirectional transmissions) such that PAs are transmitted only one-way from a network device (e.g., access point) to one or more wireless communication devices (ESLs).

Periodic Advertisement with Response (PAwR) can be used for ESL systems to provide bidirectionality (e.g., bidirectional transmissions between a central device and one or more peripheral devices). Wireless communication devices (e.g., peripheral devices, such as ESLs) synchronized within a group of wireless communication devices can be addressed by a network device (e.g., AP) on a synchronized channel (e.g., a radio frequency (RF) channel between the network device and the wireless communication devices) whenever the network device chooses to send (e.g., transmit) a request to the wireless communication devices. In some cases, as used herein, a synchronized channel refers to a channel on which transmissions are synchronized (in time). For example, the channel includes a frequency on which one or more communications are transmitted. A hopping frequency sequence defines the channel, where the sequence progresses at a fixed determine interval. A central device and one or more peripheral devices can concurrently track the sequence at the predefined frequency hopping pattern (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a wireless communication device is expected by the network device (e.g., the synchronization message from the network device requests a response from a specific wireless communication device), the particular wireless communication device will respond in a specific response slot, which may be based on where the wireless communication device appeared within a sequence contained within the synchronization message transmitted by the network device.

ESL systems are typically deployed to support and manage ESL devices in stores (e.g., supermarkets) and in industrial warehouses. In stores, ESLs are typically employed as electronic labels that are affixed to store shelves to identify the items and the price of the items located on the store shelf above the label. ESLs may be each implemented with a display (e.g., a liquid crystal display (LCD), an electronic paper (e-paper) display, etc.). The ESL may digitally display the name of the item, a product identification number for the item, such as a stock keeping unit (SKU) number, and a price for the item. The ESL may additionally display a barcode for the item, a quick response (QR) code for the item, and/or an image (e.g., a picture) of the item. During operation of the ESL system, the information displayed on the ESLs may be updated periodically by using PAs.

Users (or customers) in large stores (e.g., supermarkets, home improvement stores and/or warehouse stores) often have questions regarding some of the items for sale. For example, users may have questions regarding the availability of certain items or when the items are out of stock on the shelves, questions requesting help to access certain items when the items are located on shelves that are out of reach, and/or product-related questions about the items themselves. Users may seek employees working in the store for help with answering their questions about the items. However, for example due to the size of a store, it can be difficult for customers to locate employees to provide them with real-time support for their questions. As such, users will typically need to move throughout the store to locate a store employee for assistance.

Systems and techniques are described herein that extend usage of wireless communication devices, such as electronic shelf labels (ESLs), for managing real-time requests from users (e.g., a customer of a store seeking assistance from store employee, an employee in a warehouse seeking assistance from a supervisor, etc.). For example, the systems and techniques provide a solution for using ESLs to efficiently manage a real-time request from a user (e.g., a customer) to an entity (e.g., an assistant, such as a store employee). In some cases, the systems and techniques extend the device types of ESLs (e.g., in an ESL-based Standard document) to include an employee electronic badge (E-Badge) device type and/or an electronic rack badge (E-RackBadge) device type. Other device types can also be defined. In one illustrative example, store employees can each wear an ESL in the form of an E-Badge, and objects (e.g., shelving units) in a store that house items for sale can each have one or more ESLs affixed in the form of an E-RackBadge. For instance, each shelf in a store that holds items for sale can have one or more respective ESLs affixed thereto. In some aspects, the E-Badge may display information related to the employee (e.g., an employee identification number, which may be in the form of a QR code or a barcode) and the duties of the employee (e.g., the shelving unit(s) serviced by the employee during their shift). In some cases, the E-RackBadge may display information related to the shelving unit (e.g., a shelving unit identification number, which may be in the form of a QR code or a barcode) and the items housed within the shelving unit.

The systems and techniques can employ ESLs with these new device types to provide real-time support to one or more users (e.g., a customer of a store seeking assistance from store employee, an employee in a warehouse seeking assistance from a supervisor, etc.). In one or more examples, a customer may scan with a computing device (e.g., a mobile phone, a tablet, a network-connected wearable such as a watch, etc.) an E-RackBadge (e.g., scan a QR code or a barcode displayed on the E-RackBadge) affixed to a shelving unit housing items for which the customer seeks assistance from an entity (e.g., an employee of the store). After the customer scans the E-RackBadge using the computing device, the E-Badge of the employee supporting that particular shelving unit will notify (e.g., alert) the employee to proceed to that particular shelving unit to provide immediate assistance to the customer. In some aspects, the systems and techniques can check a correlation between a location of the computing device of the user and a scanned ESL location to ensure that the computing device and ESL are co-located.

In one or more examples, the systems and techniques may employ various different techniques, instead of scanning an E-RackBadge with a computing device, to trigger an E-Badge to notify a person (e.g., an employee of a store, a manager of a warehouse, etc.) of a user's (e.g., a customer of the store, an employee of the warehouse, etc.) need for assistance. The different techniques may include, but are not limited to, an application (APP) running on a computing device associated with the user (e.g., customer, etc.), a push button or switch associated with an ESL, and/or a location system for locating the user (e.g., customer, etc.).

For example, the systems and techniques may utilize an application (e.g., a store application) running on a computing device, which may be associated with a user (e.g., a customer of a store, an employee of a warehouse, etc.), to trigger an E-Badge to notify a person in an environment (e.g., an employee in the store, a manager in the warehouse, etc.) of the user's (e.g., customer, etc.) need for assistance. For instance, during operation, when a customer desires assistance from an employee in a store, the customer may request assistance for particular items and/or for a particular shelving unit within the store via the application running on the employee's computing device. After the customer requests assistance via the application on the computing device, the E-Badge of the employee supporting those particular items and/or shelving unit will notify (e.g., alert) the employee to proceed to the particular items and/or the shelving unit to provide immediate assistance to the employee.

In another example, the systems and techniques may use a push button or switch associated with (and/or located on) an ESL to trigger an E-Badge to notify a person (e.g., an employee of a store, a manager of a warehouse, etc.) of a user's need for assistance (e.g., a customer of the store, an employee of the warehouse, etc.). For instance, during operation, a customer of a store may press (or switch) a button (or switch) associated with (e.g., located on) an ESL (e.g., an electronic label to identify items for sale and/or an E-RackBadge to identify a shelving unit) when the customer desires assistance from an employee of the store. After the customer presses (or switches) with button (or switch), the E-Badge of the employee supporting those particular items and/or shelving unit will notify (e.g., by outputting an alert) the employee to proceed to the items and/or the shelving unit to provide immediate assistance to the customer.

In another example, the systems and techniques may employ a location system for correlating a location of a user (e.g., a customer of a store, an employee of a warehouse, etc.) with a location of an associated point of interest (e.g., a shelving unit itself or items located within a shelving unit of the store, warehouse, or other environment). For instance, the location system may be utilized, instead of scanning an E-RackBadge, for triggering an E-Badge to notify an employee of a store that a customer is in need of assistance from the employee. For the location system, one or more ESLs (e.g., an electronic label to identify items for sale and/or an E-RackBadge to identify a shelving unit) within the store may additionally include one or more antennas (e.g., a phased array antenna), and each ESL may be associated with a point of interest. The one or more antennas of an ESL may be used for locating a customer, who may need assistance within an aisle of the store, with respect to a point of interest.

In some cases, during operation of the location system, an antenna (e.g., phased array antenna) of an ESL (e.g., which may be associated with a point of interest) may transmit a signal towards a customer. The signal may reflect off of the customer to produce a reflection signal. The reflection signal may then be received by the antenna of the ESL. At least one processor of the ESL may process the received reflection signal (e.g., perform ranging using the reflection signal) to determine a location of the customer with respect to the location of the ESL. After the ESL has correlated the location of the customer with the location of the ESL (e.g., which is associated with the location of the point of interest), the E-Badge of the employee supporting the point of interest associated with that particular ESL will notify (e.g., alert) the employee to proceed to the point of interest associated with the ESL to provide immediate assistance to the customer.

The systems and techniques provide a method to manage real-time interactions between customers and store employees to provide a better overall shopping experience for customers. The shelving units, ESLs (e.g., including E-RackBadges and E-Badges), customers, and employees in the store together form an ecosystem that is an intelligent system. This intelligent system can allow for customers to locate desired items easily and quickly, customers to obtain assistance from store employees easily, and employees to reach the customers who need help quickly.

While aspects and examples are described herein using customers of a store as illustrative examples of users and store employees as illustrative examples of assistants from which the users' can seek help via the ESLs implemented using the systems and techniques described herein, the systems and techniques can apply to other types of users (e.g., employees in a warehouse, patrons of an amusement park, etc.) and assistants (e.g., a supervisor of a warehouse, an employee or volunteer in an amusement park, etc.).

Additional aspects of the present disclosure are described in more detail below.

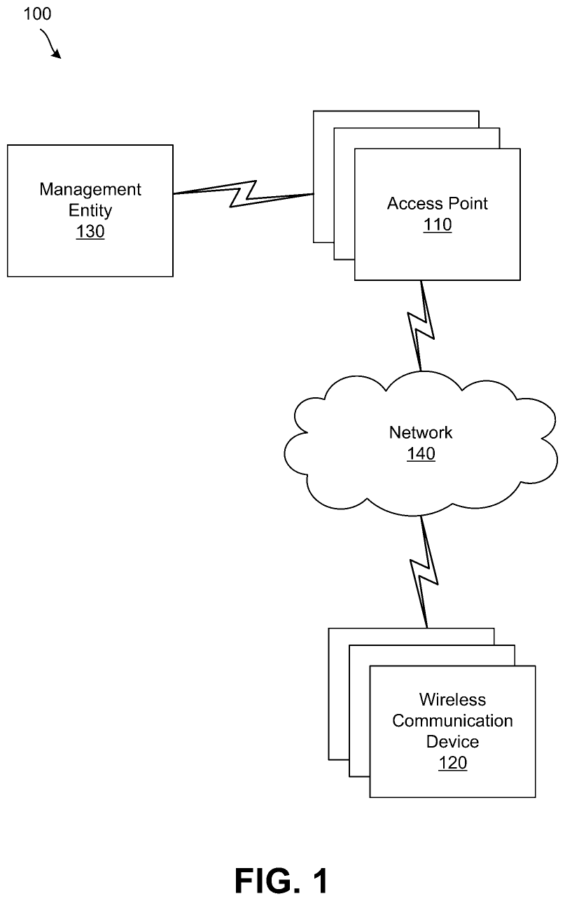

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

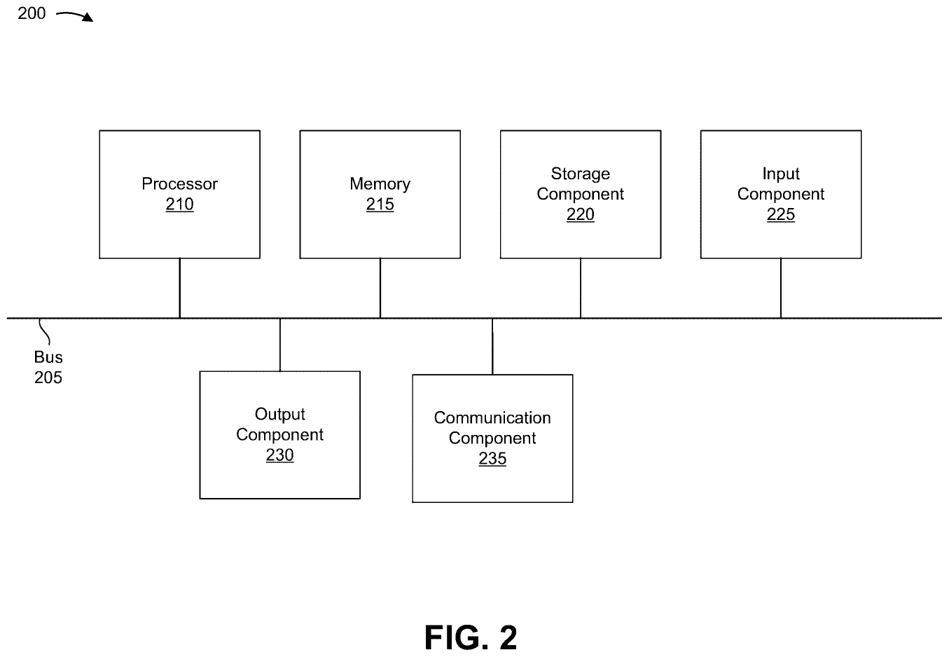

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., an indoor location component or system that can be based on a plan-o-gram of an environment in which the device 200 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As previously mentioned, in ESL systems, PAs are often utilized to provide regular and predictable payload transmissions from a network device, such as an access point, to one or more wireless communication devices, such as ESLs. PAs can be used to issue information from a network device to multiple wireless communication devices, which may be within one or more groups of wireless communication devices. PAs are generally unidirectional (e.g., unidirectional transmissions) such that PAs are transmitted only one-way from a network device (e.g., access point) to one or more wireless communication devices (ESLs).

Periodic Advertisement with Response (PAwR) was introduced to ESL systems to provide bidirectionality (e.g., bidirectional transmissions between a network device, such as an access point, and one or more wireless communication devices, such as ESLs). Wireless communication devices (e.g., ESLs) synchronized within a group of wireless communication devices can be addressed by a network device (e.g., AP) on a synchronized channel (e.g., a synchronized frequency channel between the network device and the wireless communication devices) whenever the network device chooses to send (e.g., transmit) a request (e.g., a PA containing a synchronization message transmitted on the synchronized channel) to the wireless communication devices. If a response from a wireless communication device is expected by the network device (e.g., the synchronization message from the network device requests a response from a specific wireless communication device), the particular wireless communication device will respond in a specific response slot, which may be based on where the wireless communication device appeared within a sequence contained within the synchronization message transmitted by the network device.

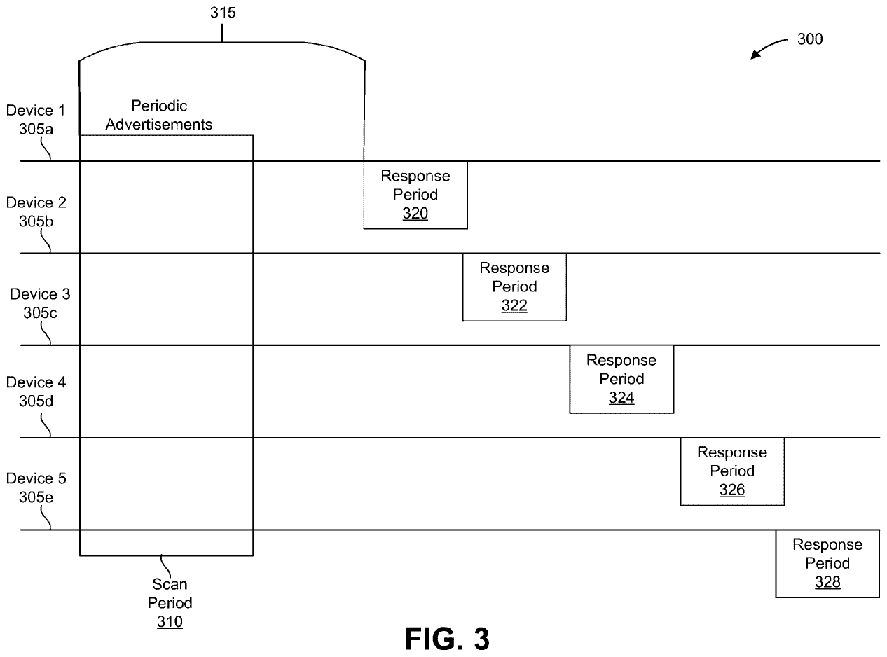

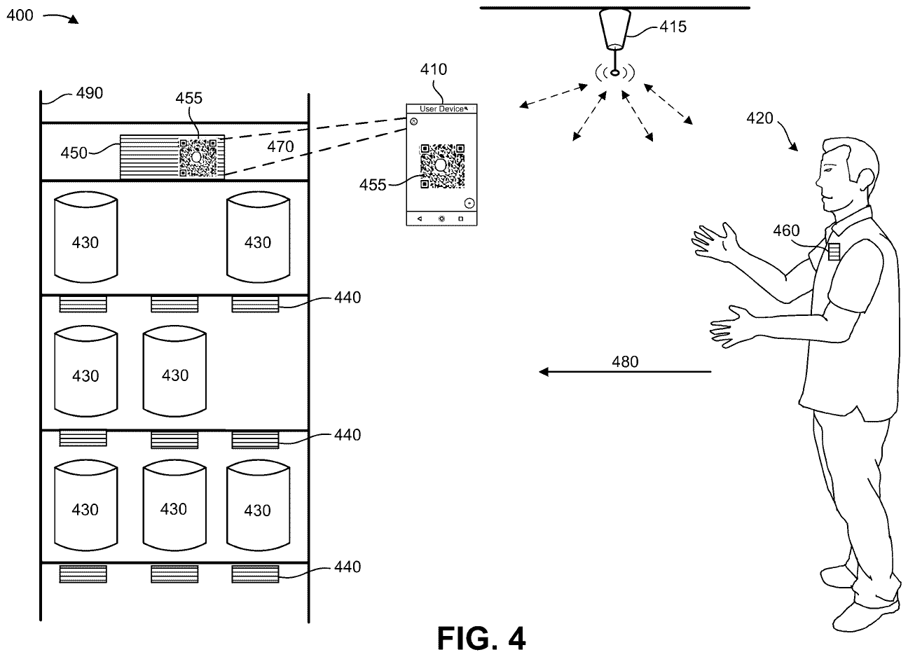

FIG. 3 shows a signaling diagram illustrating examples of PAwR in an ESL system including a group of wireless network devices (e.g., device 1 305a, device 2 305b, device 3 305c, device 4 305d, and device 5 305e). In particular, FIG. 3 is a signal timing diagram illustrating a portion of a communication between a network device (e.g., an access point, such as access point 110 of FIG. 1 and/or network device 415 of FIG. 4) and wireless communication devices (e.g., wireless communication devices 120 of FIG. 1 and/or wireless communication devices 440, 450, and/or 460 of FIG. 4, which may all be in the form of ESLs). As such, with reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train (e.g., a PA train or PAwR train). One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

As previously mentioned, currently, ESL systems are deployed to support and manage ESL devices in stores (e.g., supermarkets) and in industrial warehouses. In stores, ESLs are typically employed as electronic labels that are affixed to store shelves to identify the items and the price of the items located on the store shelf above the label. ESLs can be each implemented with an LCD or an e-paper display. The ESL can digitally display the name of the item, a product identification number for the item (e.g., a SKU number), and a price for the item. The ESL may additionally display a barcode for the item, a QR code for the item, and/or an image (e.g., a picture) of the item. During operation of the ESL system, the information displayed on the ESLs can be updated periodically by using PAs.

Customers shopping in large stores (e.g., supermarkets, home improvement stores and/or warehouse stores) frequently have questions regarding some of the items for sale. For example, customers may have questions regarding the availability of certain items when the items are out of stock on the shelves, questions requesting help to access certain items when the items are located on shelves that are out of reach, and/or product-related questions about the items themselves. Customers may seek employees working in the store for help with answering their questions about the items. However, currently, with many stores being very large, it is often difficult for customers to locate employees to provide them with real-time support for their questions. As such, customers will typically need to walk up and down various different aisles of the store to locate a store employee for assistance.

Systems and techniques extend usage of wireless communication devices, such as electronic shelf labels (ESLs), for managing customers' real-time requests. In particular, the systems and techniques provide a solution for using ESLs to efficiently manage a real-time request from a customer to a store employee. Specifically, the systems and techniques extend the device types of ESLs to include an employee electronic badge (E-Badge) device type and an electronic rack badge (E-RackBadge) device type. In one or more examples, store employees can each wear an ESL in the form of an E-Badge. The shelving units, which house items for sale, can each have an ESL affixed to itself in the form of an E-RackBadge. The E-Badge can display information related to the employee (e.g., an employee identification number, which may be in the form of a QR code or a barcode) and the duties of the employee (e.g., the shelving unit(s) serviced by the employee during their shift). And, similarly, the E-RackBadge may display information related to the shelving unit (e.g., a shelving unit identification number, which may be in the form of a QR code or a barcode) and the items housed within the shelving unit.

The systems and techniques employ ESLs with these new device types to provide real-time support to the customer. In one or more examples, a customer may scan with their smart device (e.g., a smart phone or tablet) an E-RackBadge (e.g., scan a QR code or a barcode displayed on the E-RackBadge) affixed to a shelving unit housing items that the customer seeks assistance from an employee. After the customer scans the E-RackBadge, the E-Badge of the employee supporting that particular shelving unit will notify (e.g., alert) the employee to proceed to that particular shelving unit to provide immediate assistance to the customer.

FIG. 4 shows an example system that extends usage of wireless communication devices (e.g., ESLs) to include an employee E-Badge device type and an E-RackBadge device type for managing customers' real-time requests. In particular, FIG. 4 is a diagram illustrating an example of a system 400 for using wireless communication devices 450, 460, such as ESLs, for managing customers' real-time requests. With reference to FIG. 1, the system 400 illustrated in FIG. 4 may be implemented by one or more of the communication connections, access points 110, and/or wireless communication devices 120 of FIG. 1.

In FIG. 4, the system 400 may be located within a large store (e.g., a home improvement store or supermarket). The system 400 may include at least one shelving unit 490 containing a plurality of shelves housing items 430 (e.g., paint cans) for sale. Wireless communication devices 440 (e.g., ESLs) may be affixed to the shelves. The wireless communication devices 440 (e.g., ESLs) can display information relating to the items 430 located on the store shelf above the wireless communication devices 440. Each of the wireless communication devices 440 (e.g., ESLs) may be implemented with an LCD or an e-paper display for displaying the information. The wireless communication devices 440 (e.g., ESLs) can digitally display (e.g., on the LCD or e-paper display) the information, which may include, but is not limited to, the name and/or identity of the items 430, a product identification number for the items 430 (e.g., a SKU number), a price for the items 430, a barcode for the items 430, a QR code for the items 430, and/or an image (e.g., a picture) of the items 430. During operation of the system 400, the information displayed on the wireless communication devices 440 (e.g., ESLs) can be updated (e.g., changed) periodically via PAs.

In one or more examples, the shelving unit 490 may also have a wireless communication device 455 (e.g., an ESL) in the form of an E-RackBadge mounted onto itself. The wireless communication device 450 (e.g., E-RackBadge) may display information related to the shelving unit 490. The wireless communication device 450 (e.g., E-RackBadge) may be implemented with an LCD or an e-paper display for displaying the information. The wireless communication device 450 can digitally display (e.g., on the LCD or e-paper display) the information, which may include, but is not limited to, a general description of the type(s) of items 430 contained within the shelving unit 490, an identification number (e.g., a unique identifying number) for the shelving unit 490, a barcode for the shelving unit 490, a QR code (e.g., such as QR code 455) for the shelving unit 490, a name of an employee(s) (e.g., employee 420) that is servicing the shelving unit 490 on their shift, an identification number of the employee(s) (e.g., employee 420) that is servicing the shelving unit 490, a product identification number for the items 430 (e.g., a SKU number) in the shelving unit 490, a price for the items 430 in the shelving unit 490, an image (e.g., a picture) of the items 430 located within the shelving unit 490, and/or an image (e.g., photograph) of the employee(s) (e.g., employee 420) that is servicing the shelving unit 490. Similar to the wireless communication devices 440 (e.g., ESLs), the information displayed on the wireless communication device 450 (e.g., E-RackBadge) can be updated (e.g., changed) periodically via PAs.

In the system 400 of FIG. 4, an employee 420 of the store is shown to be wearing a wireless communication device 460 (e.g., ESL) in the form of an E-Badge. The wireless communication device 460 (e.g., E-Badge) may display information related to the employee 420, who is working their shift at the store. The wireless communication device 460 (e.g., E-Badge) can be implemented with an LCD or an e-paper display for displaying the information. The wireless communication device 460 (e.g., E-Badge) may digitally display (e.g., on the LCD or e-paper display) the information, which may include, but is not limited to, the name of the employee 420, an identification number for the employee 420, a barcode for the employee 420, a QR code for the employee 420, shelving unit identification number(s) of the shelving unit(s) (e.g., shelving unit 490) supported by the employee 420 during their shift, a general description of the area(s) (e.g., the paint can area of the store) supported by the employee 420 during their shift, and/or an image (e.g., photograph) of the employee 420. The information displayed on the wireless communication device 460 (e.g., E-Badge) can be updated (e.g., changed) periodically (e.g., when the employee 420 works different shifts and/or is assigned to support different shelving units in the store) via PAs.

The system 400 of FIG. 4 may also include a network device 415 (e.g., an access point) that may be mounted to the ceiling of the store. The network device 415 (e.g., access point) can communicate with the wireless communication devices 440, 450, 460 (e.g., ESLs) wirelessly, such as via Bluetooth.

In one or more examples, the system 400 of FIG. 4 may employ customer real-time support packet (CRTP) advertising to notify a store employee (e.g., employee 420) that a customer needs assistance regarding items (e.g., items 430, such as paint cans) located on a specific shelving unit (e.g., shelving unit 490). The generation of the CRTP advertising may be via Bluetooth communications or via Internet communications. The following are examples for operation of the system 400 of FIG. 4 performing CRTP advertising generation via Bluetooth communications and for operation of the system 400 of FIG. 4 performing CRTP advertising generation via Internet communications.

In one or more examples, during operation of the system 400 of FIG. 4 employing CRTP advertising generation via Bluetooth, when a customer needs real-time support from a store employee (e.g., employee 420) regarding a specific item 430 (e.g., can of paint) or items, the customer can use an application (App) of the store running on his smart device 410 (e.g., a wireless communication device in the form of a smart phone or a tablet) to scan (e.g., obtain an image of) a code (e.g., a QR code 455) displayed on a wireless communication device 450 (e.g., ESL) in the form of a E-RackBadge affixed to the shelving unit 490 housing the particular item 430 or items. After the customer uses his smart device 410 to scan the code (e.g., QR code 455) on the wireless communication device 450 (e.g., E-RackBadge), the store's App can cause the smart device 410 to display to the customer on the display of the smart device 410 information related to the shelving unit 490 (e.g., a shelving unit 490 identification number) and information related to the employee 420 currently on duty supporting the shelving unit 490 (e.g., an employee 420 identification number).

After the customer uses his smart device 410 to scan the code (e.g., QR code 455) on the wireless communication device 450 (e.g., E-RackBadge), the store's App running on the customer's smart device 410 (e.g., smart phone) can trigger CRTP advertising via Bluetooth communications between the smart device 410 (e.g., smart phone) and the network device 415 (e.g., access point). As such, the smart device 410 may send (e.g., transmit) user support information (e.g., customer support information, such as CRTP advertising) to the network device 415 (e.g., access point) via Bluetooth communications. A packet format of the CRTP advertising can be managed by the store's App running on the smart device 410. A packet of the user support information (e.g., a CRTP advertising packet) may include information related to the shelving unit 490 (e.g., a shelving unit 490 identification number) and information related to the employee 420 currently on duty supporting the shelving unit 490 (e.g., an employee 420 identification number).

In one or more examples, the CRTP advertising may be legacy advertising (e.g., non-ESL BLE advertising) or ESL advertising that can use a free (available) ESL response slot to convey the information towards the network device 415 (e.g., access point) using data channels utilized by the network device 415 (e.g., the smart device 410 may have pre-knowledge of the frequency hopping sequence (FHS) of the network device 415). The smart device 410 may or may not need to be on-boarded to the ESL system.

The network device 415 (e.g., access point) can scan for (e.g., scan to receive) and report the CRTP advertising packets sent (e.g., transmitted) from the smart device 410 via Bluetooth communications. After the network device 415 (e.g., access point) has received the CRTP advertising packets and reported the CRTP advertising packets, the network device 415 (e.g., access point) can obtain information from the CRTP advertising packets. The obtained information may be related to the shelving unit 490 (e.g., a shelving unit 490 identification number) and related to the employee 420 currently on duty supporting the shelving unit 490 (e.g., an employee 420 identification number).

In one or more examples, the network device 415 (and/or the smart device 410) may compare the location of the smart device 410 with the location of the wireless communication device 450 (e.g., E-RackBadge) to confirm that the location of the smart device 410 is the same as or is in close proximity to the location of the wireless communication device 450. In one or more examples, the network device 415 may proceed with the operation of the system 400, if it is determined that the locations are the same or are in close proximity of each other. In some examples, the network device 415 may not proceed with the operation of the system 400, if it is determined that the locations are not the same or are not in close proximity of each other. In some cases, such a location check can be performed when an employee (e.g., employee 420) or other user (e.g., a customer) has not scanned a code (e.g., a QR code 455) of the wireless communication device 450 (e.g., E-RackBadge). In one or more examples, such as when an employee or other user scans a code (e.g., a QR code 455) of the wireless communication device 450 (e.g., E-RackBadge), validation of the location of the scanned wireless communication device 450 can be used as an additional check.

After the network device 415 (e.g., access point) has obtained the information, the network device 415 may send (e.g., transmit) via Bluetooth communications a CRTP request to the wireless communication device 460 (e.g., E-Badge) of the specific employee 420. The CRTP request may include information related to the shelving unit 490 (e.g., a shelving unit 490 identification number) and related to the employee 420 currently on duty supporting the shelving unit 490 (e.g., an employee 420 identification number).

After the wireless communication device 460 (e.g., E-Badge) receives the CRTP request, the wireless communication device 460 (e.g., E-Badge) can issue to the employee 420 a prompt (e.g., an alert, which can be textual and/or audible) containing the shelving unit 490 identification number. After the employee 420 receives the prompt on the wireless communication device 460 (e.g., E-Badge), the employee 420 can proceed (e.g., walk) in a direction 480 towards the shelving unit 490 to provide the customer at the shelving unit 490 with real-time support.

In one or more examples, during operation of the system 400 of FIG. 4 employing CRTP advertising generation via Internet, when a customer needs real-time support from a store employee (e.g., employee 420) regarding a specific item 430 (e.g., can of paint) or items, the customer can use the store's App running on his smart device 410 (e.g., a wireless communication device in the form of a smart phone or a tablet) to scan (e.g., obtain an image of) a code (e.g., a QR code 455) displayed on a wireless communication device 450 (e.g., E-RackBadge) affixed to the shelving unit 490 containing the specific item 430 or items. After the customer uses his smart device 410 to scan the code (e.g., QR code 455) on the wireless communication device 450 (e.g., E-RackBadge), the store's App can cause the smart device 410 to display on the display of the smart device 410 information related to the shelving unit 490 (e.g., the shelving unit 490 identification number) and information related to the employee 420 on duty servicing the shelving unit 490 (e.g., the employee 420 identification number).

After the customer uses his smart device 410 to scan the code (e.g., QR code 455) on the wireless communication device 450 (e.g., E-RackBadge), the store's App running on the customer's smart device 410 (e.g., smart phone) can send (e.g., transmit) CRTP information to the network device 415 (e.g., access point) via Internet communications. The CRTP information may include information related to the shelving unit 490 (e.g., the shelving unit 490 identification number) and information related to the employee 420 currently on duty supporting the shelving unit 490 (e.g., the employee 420 identification number).

After the network device 415 (e.g., access point) has received the CRTP information via the Internet, the network device 415 (e.g., access point) may obtain the specific information within the CRTP information. After the network device 415 (e.g., access point) has obtained the information, the network device 415 can send (e.g., transmit) via Bluetooth communications a CRTP request to the wireless communication device 460 (e.g., E-Badge) of the employee 420. The CRTP request may include information related to the shelving unit 490 (e.g., the shelving unit 490 identification number) and information related to the employee 420 currently on duty servicing the shelving unit 490 (e.g., the employee 420 identification number).

After the wireless communication device 460 (e.g., E-Badge) receives the CRTP request, the wireless communication device 460 (e.g., E-Badge) may issue to the employee 420 a prompt (e.g., an alert, which may be textual and/or audible) containing the shelving unit 490 identification number. After the employee 420 receives the prompt on the wireless communication device 460 (e.g., E-Badge), the employee 420 may proceed (e.g., walk) in a direction 480 towards the shelving unit 490 to assist the customer at the shelving unit 490.

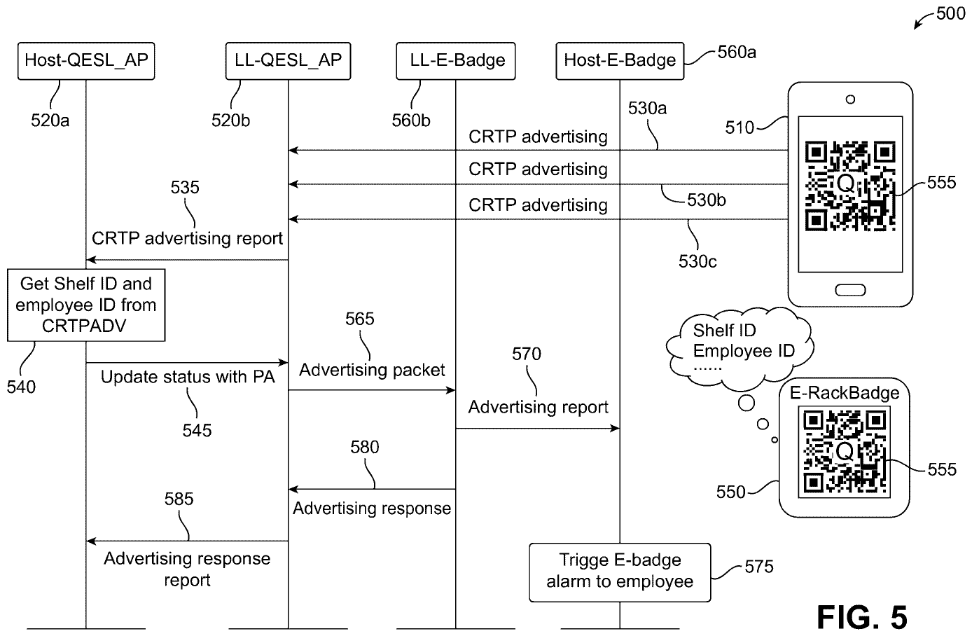

FIG. 5 is a signaling diagram illustrating an example of communication transmissions 500 for between a network device (e.g., an access point) and wireless communication devices (e.g., ESLs with device types of an E-RackBadge and an E-Badge). In FIG. 5, during operation, when a customer needs real-time support from a store employee regarding a specific item or items, the customer can use an App of the store running on his smart device 510 (e.g., in the form of a smart phone) to scan (e.g., obtain an image of) a code (e.g., a QR code 555) displayed on a wireless communication device 550 (e.g., ESL) in the form of a E-RackBadge affixed to the shelving unit containing the particular item or items.

After the customer uses his smart device 510 (e.g., smart phone) to scan the code (e.g., QR code 455) on the wireless communication device 550 (e.g., E-RackBadge), the store's App may cause the smart device 510 to display to the customer on the display of the smart device 510 information related to the shelving unit (e.g., a shelving unit identification number) and information related to the employee on duty supporting the shelving unit (e.g., an employee identification number).

After the customer uses his smart device 510 to scan the code (e.g., QR code 555) on the wireless communication device 550 (e.g., E-RackBadge), the store's App running on the customer's smart device 510 (e.g., smart phone) may trigger CRTP advertising via Bluetooth communications between the smart device 510 (e.g., smart phone) and the network device (e.g., access point link layer 520b). As such, the smart device 510 (e.g., smart phone) can send (e.g., repeatedly transmit) CRTP advertising packets 530a, 530b, 530c to the network device (e.g., access point link layer 520b) via Bluetooth communications. The CRTP advertising packet format may be managed by the store's App running on the smart device 510. The CRTP advertising packets 530a, 530b, 530c may include information related to the shelving unit (e.g., the shelving unit identification number) and information related to the employee on duty supporting the shelving unit (e.g., the employee identification number).

The CRTP advertising packets 530a, 530b, 530c may be legacy advertising (e.g., non-ESL BLE advertising) or ESL advertising that can use a free ESL response slot to convey the information towards the network device (e.g., access point link layer 520b) using data channels utilized by the network device (e.g., the smart device 510 may have pre-knowledge of the FHS of the network device). The smart device 510 may or may not need to be on-boarded to the ESL system.

The network device (e.g., access point link layer 520) can scan for (e.g., scan to receive) the CRTP advertising packets 530a, 530b, 530c sent (e.g., transmitted) from the smart device 510 via Bluetooth communications. After the network device (e.g., access point link layer 520b) has received the CRTP advertising packets 530a, 530b, 530c, the network device (e.g., access point link layer 520b) can report the CRTP advertising packets 535 to the network device (e.g., access point host 520a). The network device (e.g., access point host 520a) can then obtain 540, from the CRTP advertising packets 530a, 530b, 530c, the information related to the shelving unit (e.g., the shelving unit identification number) and information related to the employee on duty supporting the shelving unit (e.g., the employee identification number).

After the network device (e.g., access point host 520a) has obtained the information, the network device (e.g., access point host 520a) can send (e.g., transmit) via Bluetooth communications updated status with PA 545, such as an access point synchronization operational code (AP SYNC Opcode), to the network device (e.g., access point link layer 520b). The network device (e.g., access point link layer 520b) can then transmit a CRTP request (e.g., an advertising packet 565) to a wireless communication device (e.g., E-Badge link layer 560b) of the specific employee. The CRTP request (e.g., an advertising packet 565) may include information related to the shelving unit (e.g., the shelving unit identification number) and information related to the employee currently on duty supporting the shelving unit (e.g., the employee identification number).

The wireless communication device (e.g., E-Badge link layer) can then report the CRTP request (e.g., an advertising report 570) to a wireless communication device (e.g., E-Badge host 560a) of the specific employee. The wireless communication device (e.g., E-Badge host 560a) of the specific employee may then trigger 575 a prompt (e.g., an alarm, which may be textual and/or audible) to notify the employee of the shelving unit identification number. The employee can then proceed to the shelving unit to provide real-time assistance to the customer.

Then, the wireless communication device (e.g., E-Badge link layer 560b) may send (e.g., transmit) an advertising response 580 to the network device (e.g., access point link layer 520b). The network device (e.g., access point link layer 520b) may report the advertising response 585 to the network device (e.g., access point host 520a).

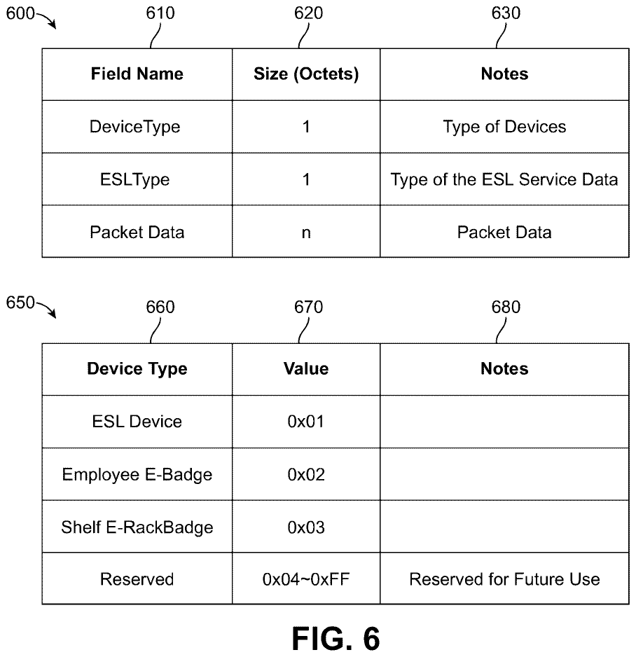

As previously mentioned, the systems and techniques extend usage of wireless communication devices (e.g., ESLs) for managing customers' real-time requests. In particular, the systems and techniques can extend the device types of ESLs to include an employee E-Badge device type and a shelving unit E-RackBadge device type. FIG. 6 includes tables 600, 650 showing examples of different device types for wireless communication devices (e.g., ESLs) that may be employed for the disclosed systems.

In FIG. 6, table 600 is shown to contain three columns, which may include a field name column 610, a size (in Octets) column 620, and a notes column 630. The field name column 610 is shown to include a device type field. Table 650 of FIG. 6 shows an example of an expansion of the device type field of the table 600. The table 650 is shown to contain three columns, which can include a device type column 660, a value column 670, and a notes column 680. The device type column 660 may include various different device types for ESL, which may include, but are not limited to, an ESL device type (e.g., an electronic shelf label for items on a shelf), an employee E-Badge device type, a shelf E-RackBadge device type, and a reserved device type (e.g., a shopping cart electronic badge).

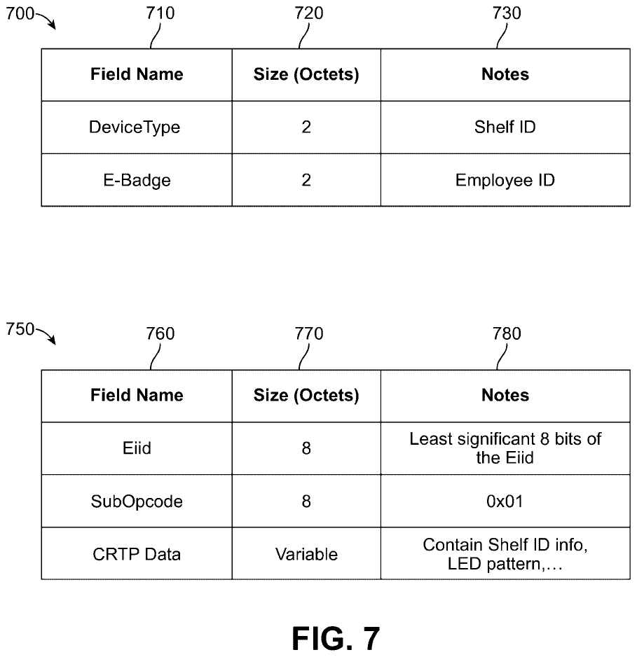

Similar to the addition of new device types (e.g., E-RackBadge and E-Badge) for ESLs, the systems and techniques can extend the ESL advertising types for CRTP. FIG. 7 includes tables 700, 750 showing examples of different advertising types for CRTP and access commands for CRTP requests that may be employed for the disclosed systems.

In FIG. 7, table 700 shows different advertising types for CRTP. Specifically, table 700 is shown to contain three columns, which may include a field name column 710, a size (in Octets) column 720, and a notes column 730. The field name column 710 is shown to include a device type field (e.g., containing a shelf identification) and an E-Badge (e.g., containing an employee identification). In one or more examples, the CRTP advertising may reuse a transmit advertising packet in the ESL system.

Table 750 shows access commands for CRTP requests. In particular, table 750 is shown to include three columns, which may include a field name column 760, a size (in Octets) column 770, and a notes column 780. The field name column 760 may include an electronic identifier identification (Eiid) field, a SubOpcode field, and a CRTP Data field.

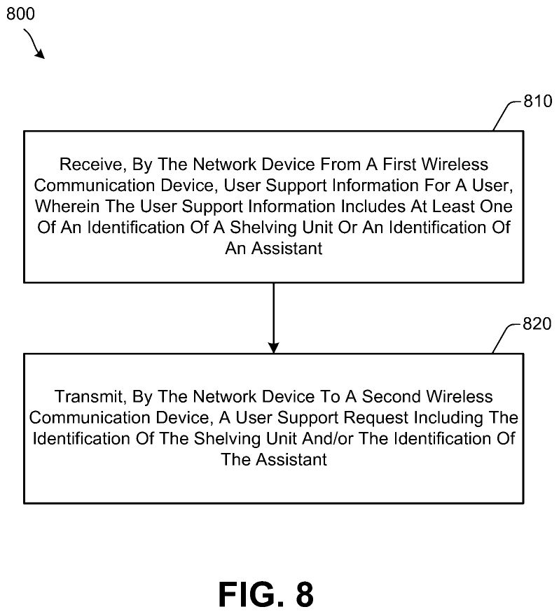

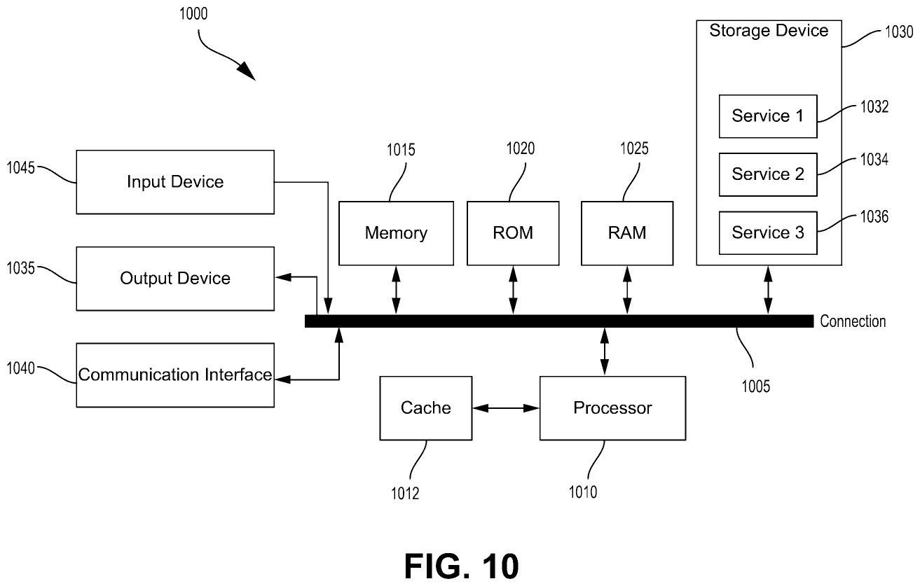

FIG. 8 is a flow chart illustrating an example of a process 800 for wireless communications utilizing methods for using wireless communication devices, such as ESLs, for managing customers' real-time requests. The process 800 can be performed by a network device (e.g., an AP, such as the AP 110 of FIG. 1 and/or the AP 415 of FIG. 4) or by a component or system (e.g., a chipset) of the network device. The operations of the process 800 may be implemented as software components that are executed and run on one or more processors (e.g., processor 1010 of FIG. 10 or other processor(s)). Further, the transmission and reception of signals by the network device in the process 800 may be enabled, for example, by one or more antennas and/or one or more transceivers such as one or more wireless transceivers (e.g., the communication component 235 of FIG. 2, the communication interface 1040 of FIG. 10, etc.).

At block 810, the network device (or component thereof) can receive, from a first wireless communication device, user support information for a user. The user support information includes an identification of a shelving unit and/or an identification of an assistant. In some cases, the first wireless communication device is associated with the user. For instance, the first wireless communication device can be a smart phone, a tablet, a wearable device (e.g., a network-connected watch), an XR device (e.g., a VR device, an AR device, etc.), or other device. In some aspects, the user support information is received by the network device via Bluetooth communications or Internet communications. In some cases, the user support information includes customer real-time support information. In some examples, the user support information is received from customer support advertising (e.g., customer real-time support packet (CRTP) advertising).

At block 810, the network device (or component thereof) can transmit, to a second wireless communication device, a user support request including the identification of the shelving unit and/or the identification of the assistant. In some cases, the user support request is transmitted by the network device via Bluetooth communications.

In some case, the second wireless communication device is associated with the assistant. For example, the second wireless communication device can be an electronic badge (E-Badge), such as the wireless communication device 460 of FIG. 4. In some aspects, the user support request is configured to trigger a prompt on the second wireless communication device. In some cases, the prompt can include the identification of the shelving unit and/or the identification of the assistant.

In some aspects, the network device (or component thereof) can receive (e.g., via Bluetooth communications) an advertising response (e.g., the advertising response 585 of FIG. 5) from the second wireless communication device.

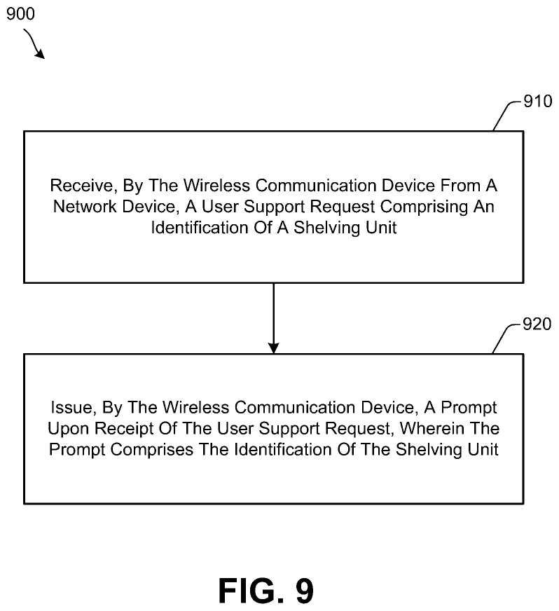

FIG. 9 is a flow chart illustrating an example of a process 900 for wireless communications utilizing methods for using wireless communication devices, such as ESLs, for managing customers' real-time requests. The process 900 can be performed by a wireless communication device (e.g., an ESL, such as wireless communication device 120 of FIG. 1 and/or wireless communication device 460 in the form of an employee E-Badge of FIG. 4) or by a component or system (e.g., a chipset) of the wireless communication device. In some cases, the wireless communication device is associated with an assistant. The operations of the process 900 may be implemented as software components that are executed and run on one or more processors (e.g., processor 1010 of FIG. 10 or other processor(s)). Further, the transmission and reception of signals by the wireless communications device in the process 900 may be enabled, for example, by one or more antennas and/or one or more transceivers (e.g., wireless transceiver(s)).

At block 910, the wireless communication device (or component thereof) can receive, from a network device, a user support request including an identification of a shelving unit. In some cases, the network device is an access point.

At block 920, the wireless communication device (or component thereof) can output (or issue) a prompt upon receipt of the user support request. The prompt includes the identification of the shelving unit.

The network device and/or wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein.

The components of the network device configured to perform the process 800 of FIG. 8 and/or the wireless communication device configured to perform the process 900 of FIG. 9 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 and the process 900 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800, process 900, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a block diagram illustrating an example of a computing system 1000, which may be employed by the disclosed systems and techniques for using wireless communication devices, such as ESLs, for managing customers' real-time requests. In particular, FIG. 10 illustrates an example of computing system 1000, which can be, for example, any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple Lightning™ Lightning ™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LIDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A method of wireless communication performed at a network device, the method comprising: receiving, by the network device from a first wireless communication device, user support information for a user, wherein the user support information comprises at least one of an identification of a shelving unit or an identification of an assistant; and transmitting, by the network device to a second wireless communication device, a user support request comprising at least one of the identification of the shelving unit or the identification of the assistant.

Aspect 2. The method of Aspect 1, wherein the network device is an access point.

Aspect 3. The method of any one of Aspects 1 or 2, wherein the first wireless communication device is associated with the user.

Aspect 4. The method of Aspect 3, wherein the first wireless communication device is one of a smart phone or a tablet.

Aspect 5. The method of any one of Aspects 1 to 4, wherein the second wireless communication device is associated with the assistant.

Aspect 6. The method of Aspect 5, wherein the second wireless communication device is an electronic badge (E-Badge).

Aspect 7. The method of any one of Aspects 1 to 6, wherein the user support request is configured to trigger a prompt on the second wireless communication device.

Aspect 8. The method of Aspect 7, wherein the prompt comprises at least one of the identification of the shelving unit or the identification of the assistant.

Aspect 9. The method of any one of Aspects 1 to 8, wherein the user support information is received via Bluetooth communications or Internet communications.

Aspect 10. The method of Aspect 9, wherein the user support information is received from customer support advertising.

Aspect 11. The method of any one of Aspects 1 to 10, wherein the user support request is transmitted via Bluetooth communications.

Aspect 12. The method of any one of Aspects 1 to 11, further comprising receiving, by the network device from the second wireless communication device, an advertising response.

Aspect 13. The method of Aspect 12, wherein the advertising response is received via Bluetooth communications.

Aspect 14. The method of any one of Aspects 1 to 13, wherein the user support information includes customer real-time support information.

Aspect 15. A network device for wireless communication, the network device comprising: at least one memory; and at least one processor coupled to the at least one memory and configured to: receive, from a first wireless communication device, user support information for a user, wherein the user support information comprises at least one of an identification of a shelving unit or an identification of an assistant; and output, for transmission to a second wireless communication device, a user support request comprising at least one of the identification of the shelving unit or the identification of the assistant.

Aspect 16. The network device of Aspect 15, wherein the network device is an access point.

Aspect 17. The network device of any one of Aspects 15 or 16, wherein the first wireless communication device is associated with the user.

Aspect 18. The network device of Aspect 17, wherein the first wireless communication device is one of a smart phone or a tablet.

Aspect 19. The network device of any one of Aspects 15 to 18, wherein the second wireless communication device is associated with the assistant.

Aspect 20. The network device of Aspect 19, wherein the second wireless communication device is an electronic badge (E-Badge).

Aspect 21. The network device of any one of Aspects 15 to 20, wherein the user support request is configured to trigger a prompt on the second wireless communication device.

Aspect 22. The network device of Aspect 21, wherein the prompt comprises at least one of the identification of the shelving unit or the identification of the assistant.

Aspect 23. The network device of any one of Aspects 15 to 22, wherein the at least one processor is configured to receive the user support information via Bluetooth communications or Internet communications.

Aspect 24. The network device of Aspect 23, wherein the at least one processor is configured to receive the user support information from customer support advertising.

Aspect 25. The network device of any one of Aspects 15 to 24, wherein the at least one processor is configured output the user support request via Bluetooth communications.

Aspect 26. The network device of any one of Aspects 15 to 25, where the at least one processor is configured to receive, from the second wireless communication device, an advertising response.

Aspect 27. The network device of Aspect 26, wherein the at least one processor is configured receive the advertising response via Bluetooth communications.

Aspect 28. The network device of any one of Aspects 15 to 27, wherein the user support information includes customer real-time support information.

Aspect 29. A method of wireless communication performed at a wireless communication device, the method comprising: receiving, by the wireless communication device from a network device, a user support request comprising an identification of a shelving unit; and outputting, by the wireless communication device, a prompt upon receipt of the user support request, wherein the prompt comprises the identification of the shelving unit.

Aspect 30. The method of Aspect 29, wherein the wireless communication device is associated with an assistant.

Aspect 31. The method of any one of Aspects 29 or 30, wherein the network device is an access point.

Aspect 32. A wireless communication device for wireless communication, the wireless communication device comprising: at least one memory; and at least one processor coupled to the at least one memory and configured to: receive, from a network device, a user support request comprising an identification of a shelving unit; and output a prompt upon receipt of the user support request, wherein the prompt comprises the identification of the shelving unit.

Aspect 33. The wireless communication device of Aspect 32, wherein the wireless communication device is associated with an assistant.

Aspect 34. The wireless communication device of any one of Aspects 32 or 33, wherein the network device is an access point.

Aspect 35. A method of wireless communication performed at a first wireless communication device, the method comprising: scanning, by the first wireless communication device, a code displayed on a second wireless communication device associated with a shelving unit; determining, by the first wireless communication device, user support information based on the code, wherein the user support information comprises at least one of an identification of the shelving unit or an identification of an assistant associated with the shelving unit; and transmitting, by the first wireless communication device to a network device, the user support information.

Aspect 36. The method of Aspect 35, wherein the first wireless communication device is associated with a user.

Aspect 37. The method of Aspect 36, wherein the first wireless communication device is one of a smart phone or a tablet.

Aspect 38. The method of any one of Aspects 35 to 37, wherein the network device is an access point.

Aspect 39. The method of any one of Aspects 35 to 38, wherein the code is one of a quick response (QR) code or a barcode.

Aspect 40. The method of any one of Aspects 35 to 39, wherein the user support information is transmitted via Bluetooth communications or Internet communications.

Aspect 41. The method of Aspect 40, wherein transmitting of the user support information uses customer support advertising.

Aspect 42. The method of any one of Aspects 35 to 41, wherein the user support information includes customer real-time support information.

Aspect 43. A first wireless communication device for wireless communication, the first wireless communication device comprising: at least one memory; and at least one processor coupled to the at least one memory and configured to: scan a code displayed on a second wireless communication device associated with a shelving unit; determine user support information based on the code, wherein the user support information comprises at least one of an identification of the shelving unit or an identification of an assistant associated with the shelving unit; and output, for transmission to a network device, the user support information.

Aspect 44. The first wireless communication device of Aspect 43, wherein the first wireless communication device is associated with a user.

Aspect 45. The first wireless communication device of Aspect 44, wherein the first wireless communication device is one of a smart phone or a tablet.

Aspect 46. The first wireless communication device of any one of Aspects 43 to 45, wherein the network device is an access point.

Aspect 47. The first wireless communication device of any one of Aspects 43 to 46, wherein the code is one of a quick response (QR) code or a barcode.

Aspect 48. The first wireless communication device of any one of Aspects 43 to 47, wherein the at least one processor is configured to transmit the user support information via Bluetooth communications or Internet communications.

Aspect 49. The first wireless communication device of Aspect 48, wherein the at least one processor is configured to output the user support information for transmission using customer support advertising.

Aspect 50. The first wireless communication device of any one of Aspects 43 to 49, wherein the user support information includes customer real-time support information.

Aspect 51. A non-transitory computer-readable medium having stored thereon instructions that, when executed by one or more processors, cause the one or more processors to perform operations according to any of Aspects 1 to 14.

Aspect 52. An apparatus for wireless communication, the apparatus including one or more means for performing operations according to any of Aspects 1 to 14.

Aspect 53. A non-transitory computer-readable medium having stored thereon instructions that, when executed by one or more processors, cause the one or more processors to perform operations according to any of Aspects 29 to 31.

Aspect 54. An apparatus for wireless communication, the apparatus including one or more means for performing operations according to any of Aspects 29 to 31.

Aspect 55. A non-transitory computer-readable medium having stored thereon instructions that, when executed by one or more processors, cause the one or more processors to perform operations according to any of Aspects 35 to 42.

Aspect 56. An apparatus for wireless communication, the apparatus including one or more means for performing operations according to any of Aspects 35 to 42.

Aspect 57. A method of wireless communication performed at a network device, the method comprising: receiving, by the network device, user support information for a user, wherein the user support information comprises at least one of an identification of a point of interest or an identification of an assistant; and transmitting, by the network device to a wireless communication device, a user support request comprising at least one of the identification of the point of interest or the identification of the assistant.

Aspect 58. The method of Aspect 57, wherein the point of interest is associated with at least one of a shelving unit or one or more items.

Aspect 59. The method of any one of Aspects 57 or 58, wherein the network device is an access point.

Aspect 60. The method of any one of Aspects 57 to 59, wherein the wireless communication device is associated with the assistant.

Aspect 61. The method of any one of Aspects 57 to 60, wherein the wireless communication device is an electronic badge (E-Badge).

Aspect 62. A network device for wireless communication, the network device comprising: at least one memory; and at least one processor coupled to the at least one memory and configured to perform operations according to any of Aspects 57 to 61.

Aspect 63. An apparatus for wireless communication, the apparatus including one or more means for performing operations according to any of Aspects 57 to 61.

Aspect 64. A non-transitory computer-readable medium having stored thereon instructions that, when executed by one or more processors, cause the one or more processors to perform operations according to any of Aspects 57 to 61.

Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A method of wireless communication performed at a network device, the method comprising:
receiving, by the network device from a first wireless communication device, user support information for a user, wherein the user support information comprises at least one of an identification of a shelving unit or an identification of an assistant; and
transmitting, by the network device to a second wireless communication device, a user support request comprising at least one of the identification of the shelving unit or the identification of the assistant.

2. The method of claim 1, wherein the network device is an access point.

3. The method of claim 1, wherein the first wireless communication device is associated with the user.

4. (canceled)

5. The method of claim 1, wherein the second wireless communication device is associated with the assistant.

6. The method of claim 5, wherein the second wireless communication device is an electronic badge (E-Badge).

7. The method of claim 1, wherein the user support request is configured to trigger a prompt on the second wireless communication device.

8. The method of claim 7, wherein the prompt comprises at least one of the identification of the shelving unit or the identification of the assistant.

9. (canceled)

10. (canceled)

11. The method of claim 1, wherein the user support request is transmitted via Bluetooth communications.

12. The method of claim 1, further comprising receiving, by the network device from the second wireless communication device, an advertising response.

13. (canceled)

14. (canceled)

15. A network device for wireless communication, the network device comprising:
at least one memory; and
at least one processor coupled to the at least one memory and configured to:
receive, from a first wireless communication device, user support information for a user, wherein the user support information comprises at least one of an identification of a shelving unit or an identification of an assistant; and
output, for transmission to a second wireless communication device, a user support request comprising at least one of the identification of the shelving unit or the identification of the assistant.

16. The network device of claim 15, wherein the network device is an access point.

17. The network device of claim 15, wherein the first wireless communication device is associated with the user.

18. (canceled)

19. The network device of claim 15, wherein the second wireless communication device is associated with the assistant.

20. The network device of claim 19, wherein the second wireless communication device is an electronic badge (E-Badge).

21. The network device of claim 15, wherein the user support request is configured to trigger a prompt on the second wireless communication device.

22. The network device of claim 21, wherein the prompt comprises at least one of the identification of the shelving unit or the identification of the assistant.

23. (canceled)

24. (canceled)

25. The network device of claim 15, wherein the at least one processor is configured output the user support request via Bluetooth communications.

26. The network device of claim 15, where the at least one processor is configured to receive, from the second wireless communication device, an advertising response.

27. The network device of claim 26, wherein the at least one processor is configured receive the advertising response via Bluetooth communications.

28. The network device of claim 15, wherein the user support information includes customer real-time support information.

29-35. (canceled)
